(19) United States
(12) Patent Application Publication
(10) Pub. No.: US 2008/0018747 A1
(43) Pub. Date: Jan. 24, 2008

(54) Solid-state image pickup module

(76) Inventor: Toshio Nakakuki, Mizuho-shi (JP)

Correspondence Address: CANTOR COLBURN, LLP, 55 GRIFFIN ROAD SOUTH, BLOOMFIELD, CT, 06002, US

(21) Appl. No.: 11/880,508

(22) Filed: Jul. 23, 2007

(30) Foreign Application Priority Data
Jul. 21, 2006 (JP) 2006-198861

(51) Int. Cl. H04N 5/225

(52) U.S. Cl. 348/207.99; 348/E05.024

(57) ABSTRACT

There are included an image pickup device including a semiconductor-based photoelectric transducer, and a control unit that includes an arithmetic part to determine an image pickup condition and controls the image pickup device based on the image pickup condition, the control unit further includes a register in which a basic clock number of a basic clock per unit time is set and stored, and the arithmetic part performs an arithmetic operation on the image pickup condition based on the basic clock number.

### CROSS-REFERENCE TO RELATED APPLICATION

This application claims priority to Japanese Patent Application No. 2006-198861, filed on Jul. 21, 2006.

### BACKGROUND OF THE INVENTION

1. Field of the Invention

The present invention relates to an improvement in operability of a solid-state image pickup module.

2. Description of the Related Art

The operation of a solid-state image pickup module including a device, such as a CCD (Charge Coupled Device) or a C-MOS (Complementary Metal Oxide Semiconductor), is determined by the number of clocks in one horizontal scanning period with respect to the basic clock as the base of control, and the horizontal scanning number in one vertical scanning period.

Also, the operation cycle of the solid-state image pickup module is generally regulated to a frame rate of 30 frames/second (Fps), 20 Fps, 5 Fps or the like based on various standards or the light emission period of a fluorescent lamp.

In the solid-state image pickup module, the frequency (basic frequency) of the basic clock can be set for each user (each maker). At this time, in order to obtain a desired frame rate, it is necessary that the number of clocks in one horizontal scanning period and the horizontal scanning number in one vertical scanning period are set in a register or the like incorporated in the solid-state image pickup module for each user.

Besides, in the solid-state image pickup module adopting a mechanical shutter, calibration for the delay time of a mechanical operation is required for each module. However, when correction is performed, only a correction value on the basis of the basic clock used at the time of the calibration can be set, and it is necessary to adjust the correction value for each end user.

### SUMMARY

According to an aspect of the invention, a solid-state image pickup module includes an image pickup device including a semiconductor-based photoelectric transducer, and a control unit that includes an arithmetic part to determine an image pickup condition and controls the image pickup device based on the image pickup condition, the control unit further includes a register in which a value corresponding to a frequency of a basic clock is set and stored, and the arithmetic part performs an arithmetic operation on the image pickup condition based on the value stored in the register.

### BRIEF DESCRIPTION OF THE DRAWINGS

Exemplary embodiment of the present invention will be described in detail on the following figures, wherein:

FIG. 1 is a block diagram showing a structure of a solid-state image pickup module in an embodiment of the invention; and

FIG. 2 is a view showing a structure of a solid-state image pickup device in the embodiment of the invention.

### DESCRIPTION OF THE PREFERRED EMBODIMENT

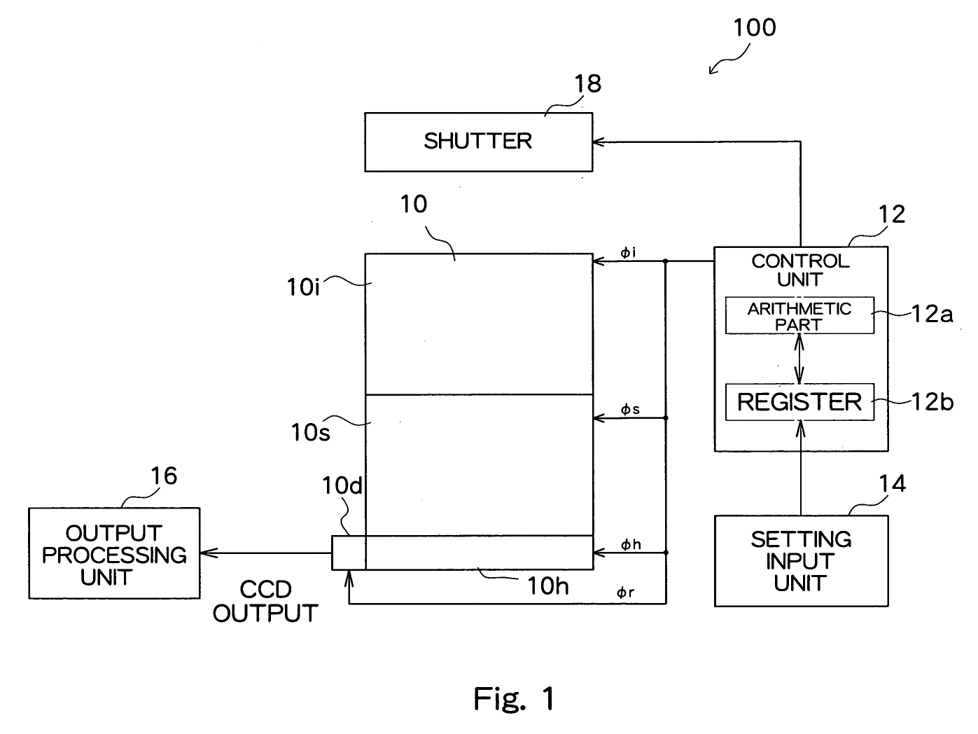

A solid-state image pickup module 100 in an embodiment of the invention includes, as shown in FIG. 1, a solid-state image pickup device 10, a control unit 12, a setting input unit 14, an output processing unit 16, and a mechanical shutter 18.

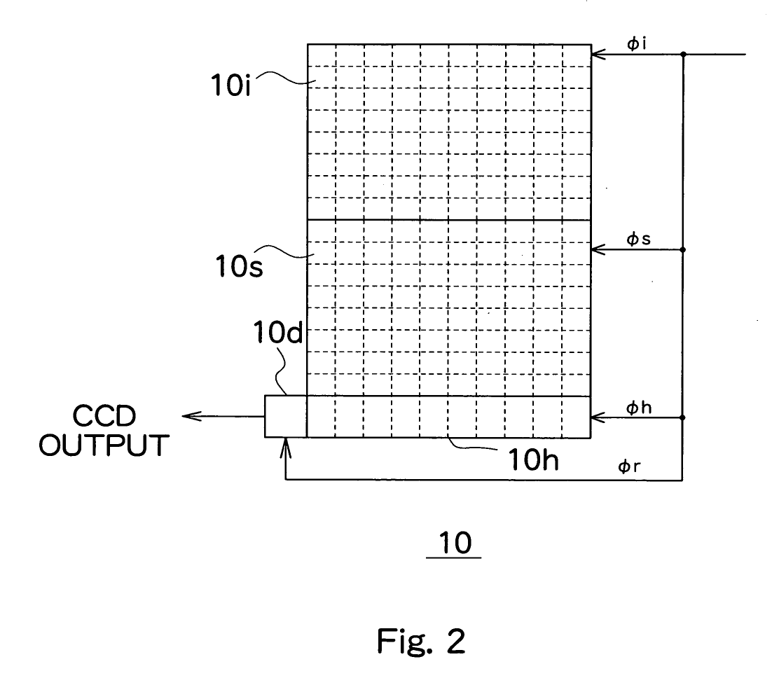

In this embodiment, the solid-state image pickup device 10 is a CCD image pickup device of a frame transfer type. The image pickup device 10 includes, as shown in FIG. 2, an image pickup unit 10i, a storage unit 10s, a horizontal transfer unit 10h and an output unit 10d.

The image pickup unit 10i includes plural vertical shift registers arranged to be parallel to each other in the vertical direction. Each bit of each of the vertical shift registers constitutes a light receiving pixel, and stores, at the time of image pickup, an information electric charge generated corresponding to the intensity of light incident from the outside. In the image pickup unit 10i, color filters of red (R), green (G) and blue (B) are arranged mosaic-wise corresponding to the respective light receiving pixels, so that a color image can be taken. At the time of transfer, in response to a vertical clock pulse φi applied to a transfer electrode from a frame clock pulse generation unit, the information electric charge stored in each pixel is transferred to the storage unit 10s. The storage unit 10s includes vertical shift registers arranged to be parallel to each other so as to be continuous with the respective vertical shift registers of the image pickup unit 10i. In response to the vertical clock pulse φs applied from a vertical clock pulse generation unit to the transfer electrode, the storage unit 10s stores the information electric charges transferred from the image pickup unit 10i and transfers them in the vertical direction. The horizontal transfer unit 10h includes a horizontal shift register arranged on the output sides of the respective vertical shift registers of the storage unit 10s. The horizontal transfer unit 10h receives a horizontal clock pulse φh applied from a horizontal clock pulse generation unit to a horizontal transfer electrode, and sequentially transfers the information electric charges transferred and outputted from the storage unit 10s to the output unit 10d. The output unit 10d has a capacitor arranged at the output side of the horizontal transfer unit 10h. The output unit 10d receives a reset clock pulse from a reset clock pulse generation unit, stores the information electric charges transferred and outputted from the horizontal transfer unit 10h into this capacitor, converts them into a voltage corresponding to the amount of the stored electric charges, and outputs it as an output signal. The voltage value of this output signal becomes an image signal.

The control unit 12 includes the arithmetic part 12a, calculates various image pickup conditions based on parameters set in the built-in register 12b by the setting input unit 14, generates the clock pulses φi, φh, φr and φs according to the image pickup conditions, and outputs them to the solid-state image pickup device 10. In this way, the control unit 12 controls an image pickup time in the solid-state image pickup device 10 and a transfer time of the information electric charge. The control unit 12 also outputs a shutter signal to the mechanical shutter 18 and controls the incidence and interruption of light to the solid-state image pickup device 10. The calculation processing of the image pickup conditions using the arithmetic part 12a will be described later.

The setting input unit 14 is a unit for receiving an input of a setting value or the like from the user to the solid solid-state image pickup module 100. The setting input unit 14 includes, for example, a combination of a display and an input button provided in a camera. The setting input unit 14 may also include a touch panel serving also as a display of liquid crystal or the like. The user uses the setting input unit 14 to perform setting of an image pickup condition or the like to the control unit 12 of the solid-state image pickup module 100.

The output processing unit 16 receives the output signal from the output unit 10d of the solid-state image pickup device 10, performs signal processing, such as amplification, color correction, smear removal and Γ correction, on the output signal, and outputs it as the image signal.

The mechanical shutter 18 is provided at the light receiving side of the image pickup unit 10i of the solid-state image pickup device 10. The mechanical shutter 18 receives a shutter signal from the control unit 12 to mechanically operate the shutter, and controls the incidence and interruption of light from the outside to the image pickup unit 10i.

Hereinafter, the calculation processing of an image pickup condition in the arithmetic part 12a of the control unit 12 will be described. The arithmetic part 12a calculates the image pickup condition based on a basic clock number N_{CLK} of a basic clock CLK per unit time (generally 1 msec), which is set in the register 12b incorporated in the control unit 12. The basic clock number N_{CLK} is previously set in the register 12b by the user using the setting input unit 14.

Incidentally, the basic clock CLK is a clock signal having a specified period as the reference of processing in the solid-state image pickup module 100, and is set to, for example, 13.5 MHz, 5 MHz, 3 MHz or the like according to the use state of the user. The basic clock number N_{CLK} is set such that in the case where the frequency of the basic clock CLK is 13.5 MHz, it is set to 13500 as a value corresponding thereto, in the case of 5 MHz, it is set to 5000 as a value corresponding thereto, and in the case of 3 MHz, it is set to 3000 as a value corresponding thereto.

Also in this embodiment, an image pickup frame number N_{FL} per unit time (generally 1 sec) and a mechanical delay time T_{DLY} of the mechanical shutter are also set in the register 12b. The image pickup frame number N_{FL} and the mechanical delay time T_{DLY} are previously set in the register 12b by the user using the setting input unit 14. It is preferable that the image pickup frame number N_{FL} is set to such a value that flicker does not occur on an image pickup screen due to the influence of the light emitting period of a fluorescent lamp, and is generally set as a value corresponding to 30 Fps (Frames Per Sec), 20 Fps, 15 Fps or the like. With respect to the mechanical delay time T_{DLY} of the mechanical shutter, a time (calibration time) desired for compensation of actual shutter operation delay is set as it is. For example, in the case where it is desired to compensate for the delay of the shutter operation by 2.2 msec, 2.2 msec is set in the register as the mechanical delay time T_{DLY} corresponding thereto.

The arithmetic part 12a reads the basic clock number N_{CLK} and the image pickup frame number N_{FL} set and stored in the register 12b, and calculates the image pickup conditions, such as the horizontal scanning number per one vertical scanning period, and the calibration value of the mechanical shutter. For example, the horizontal scanning number N_{H} per one vertical scanning period can be calculated based on numerical expression (1). Here, N_{HCLK} denotes the clock number of the basic clock CLK per one horizontal period, is a value determined according to the system, and is set in the register 12b. Incidentally, in the case where the image pickup frame number N_{FL} is set in units of seconds, it is converted into, for example, units of msec in accordance with the basic clock number N_{CLK}, and the calculation is performed.
N_{H}=N_{CLK}/(N_{FL}×N_{HCLK}) (1)

Besides, the calibration value Vc of the mechanical shutter indicating the horizontal scanning number per machine delay time T_{PLY} can be calculated based on numerical expression (2).
V_{C}=N_{CLK}×T_{DLY}/N_{HCLK} (2)

Based on the image pickup condition (here, the horizontal scanning number N_{H} per one vertical scanning period) calculated in the arithmetic part 12a, the control unit 12 generates the clock pulses φi, φh, φr and φs according to the image pickup condition, and outputs them to the solid-state image pickup device 10. In this way, horizontal synchronization and vertical synchronization can be established with respect to the output signal from the solid-state image pickup device 10. Besides, the control unit 12 corrects the output timing of the shutter signal based on the image pickup condition (here, the calibration value Vc of the mechanical shutter) calculated in the arithmetic part 12a, and outputs the shutter signal to the mechanical shutter 18.

As described above, in this embodiment, the basic clock number N_{CLK} of the basic clock CLK per unit time (generally 1 msec) is set in the register, so that the horizontal scanning number N_{H} in one vertical scanning period can be calculated using the image pickup frame number N_{FL} per unit time (normally 1 sec), and it becomes unnecessary for the user to set the horizontal scanning number N_{H} itself in one vertical scanning period into the register or the like. The calibration value Vc of the mechanical operation delay time can also be calculated using the mechanical delay time T_{DLY} of the mechanical shutter, and the user has only to set the actual time desired for compensation, not the correction value on the basis of the basic clock CLK. As stated above, the adjustment of the image pickup control in the solid-state image pickup module can be made simple and easy. The operability of the solid-state image pickup module can also be improved.

Incidentally, in this embodiment, although the structure is such that the clock N_{HCLK} of the basic clock CLK per one horizontal scanning period is set in the register 12b, the structure may be such that N_{HCLK} is calculated by the arithmetic part 12a. For example, the structure may be such that the number of pixels in the vertical direction of the solid-state image pickup device used in the solid-state image pickup module and the number of pixels in the horizontal direction are set and stored in the register 12b, and N_{HCLK} is calculated based on the number of pixels stored in the register 12b and the basic clock number N_{CLK} per unit time.

What is claimed is:

1. A solid-state image pickup module comprising:
an image pickup device including a semiconductor-based photoelectric transducer; and
a control unit that includes an arithmetic part to determine an image pickup condition and controls the image pickup device based on the image pickup condition, wherein
the control unit further includes a register in which a value corresponding to a frequency of a basic clock is set and stored, and
the arithmetic part performs an arithmetic operation on the image pickup condition based on the value stored in the register.

2. The solid-state image pickup module according to claim 1, wherein
a value corresponding to a frame rate is further set and stored in the register, and
the arithmetic part calculates a horizontal scanning number per one vertical scanning period based on the value stored in the register.

3. The solid-state image pickup module according to claim 1, wherein
a value corresponding to a delay time of a mechanical shutter is further set and stored in the register, and
the arithmetic part calculates a horizontal scanning number per delay time of the mechanical shutter based on the value stored in the register.

4. The solid-state image pickup module according to claim 2, wherein
a value corresponding to a delay time of a mechanical shutter is further set and stored in the register, and
the arithmetic part calculates a horizontal scanning number per delay time of the mechanical shutter based on the value stored in the register.
